(19) United States
(12) Patent Application Publication
(10) Pub. No.: US 2018/0308056 A1
(43) Pub. Date: Oct. 25, 2018

(54) CANDIDATE SELECTION SYSTEM AND METHOD

(71) Applicant: Larry Hartmann, Edgewater, NJ (US)

(72) Inventor: Larry Hartmann, Edgewater, NJ (US)

(21) Appl. No.: 15/492,523

(22) Filed: Apr. 20, 2017

(51) Int. Cl. G06Q 10/10; G06F 7/02

(52) U.S. Cl. CPC G06Q 10/1053; G06F 7/026

(57) ABSTRACT

A system and method includes using at least four distinct decisioning components as inputs to a computer system. Based on a candidate's score in each of the decisioning components, the system of the present invention generates a score that provides a probability of the candidate's success in an employment role. This system and method may be implemented for specialized positions such as sales and engineering positions, it is also may be used in sports teams (for evaluating athletes) and in deciding on potential Chief Executive Officers and presidents for companies. The Score is produced by a computer based process design engine and is based on a 0-100 scale. The process uses predictive analytics as well as an artificial intelligence components to continually refine the computer based system and method.

### FIELD OF THE INVENTION

The invention disclosed broadly relates to the field of personnel hiring. More particularly relates to the field of the probability for success in vetting and selecting sales personnel and the probability of success in a specific sales role.

### BACKGROUND OF THE INVENTION

Personnel hiring companies match millions of people to millions of jobs. Currently, almost three million people per day are employed by personnel hiring companies. A wide variety of methods are used to match job candidates to open positions. The process of matching candidates to positions, however, is not without its drawbacks. The odds of a successful hire are often no greater than 50 percent in today's workplace. This is because highly qualified job candidates are not responding directly to conventional advertisements and hiring managers and recruitment personal are not trained interviewers. As the demand for talented and more role specific professionals becomes increasingly high, the process becomes ever more difficult, time-consuming, and expensive to find the right candidate for a specific position.

A commonly-used approach to match job candidates to open positions involves the identification of a candidate's skills to match that candidate with an open position requiring those skills. Although this is a good way to find people who have the general qualifications for a particular position, there are a myriad of other characteristics and factors that are not considered when using this method.

Another common approach to matching job candidates to open positions involves the use of directed questions to evaluate the job candidate. The results of the evaluation are used to compare the candidate to the open position and identify a match, if any. Again, although this approach may succeed in identifying certain similarities between a job candidate and a job, there are many other factors that should be taken into consideration when hiring the right person for an open position.

Therefore, a need exists to overcome the problems with the prior art as discussed above, and particularly for a more efficient way of selecting sales candidates for an open job position.

### SUMMARY OF THE INVENTION

According to an embodiment of the present invention, a method for identifying at least one candidate for a job is disclosed. The method includes using at least four distinct decisioning components as inputs to a computer system. Based on a candidate's score in each of the decisioning components, the system of the present invention generates a score that provides a probability of the candidate's success in an employment role. This process may be implemented for specialized positions such as sales and engineering positions, it is also may be used in sports teams (for evaluating athletes) and in deciding on potential Chief Executive Officers and presidents for companies. The Score is produced by a computer based process design engine and is based on a 0-100 scale. The process uses predictive analytics as well as an artificial intelligence components to continually refine the computer based system and method.

For example, the present invention may include a system and a method to perform a matching process to match a candidate's work history and educational background to the ideal requirements of the specific role. The matching process may use key words, geographic location, education or any other suitable matching criteria to match candidates to a job position.

The system of the present invention may use remote terminals to aggregate feedback of multiple interviewers/evaluators to determine candidate's fit for a particular role. For example, the feedback of interviewers/evaluators may include a “Behavioral Evaluation” where interviewers/evaluators follow a scripted process for each interview/evaluation that is established to determine the suitability to perform in a particular role using behavior based interview questions that are designed for a particular role. The result is an aggregated score from the evaluators. The score may also be weighted in a manner that provides more or less importance to the aggregated score.

The system of the present invention may use remote terminals in a “Role Play Evaluation”. Where the of use role-play/scenario-based interviews may be used to assess a candidate's abilities to perform according to the role and the system guides the interviewer through questions and interruptions that are scripted into the interview and evaluation process.

The system of the present invention may use remote terminals in a “Simulation Evaluation” where the use of simulation tools is used to create a real-work day-to-day environment. For example, the system creates day-to-day interactions the candidate would normally encounter and evaluates how the candidate responds and creates a score based on the candidate's responses. Job specific simulations may also be further implemented for specific positions. The score may also be weighted in a manner that provides more or less importance to the aggregated score.

The system of the present invention may use remote terminals for an online assessment process where a candidate logs onto a computer system that provides the candidate a digital questionnaire. Based upon the candidate's answers and comparison to digitally stored peer-group answers, the present invention may provide a probability score of a candidate's fit to the role being assessed. The probability score may then be used in the candidate's overall score of success.

The online assessment process may focus on several areas, which may be customized to the role and to the position. The online assessment process may include:
1) A candidate's behavioral traits match the profile of the role for which they are being considered and a behavioral score may be generated and used to determine overall success in the position;
2) A candidate's intellectual results and competencies match for the profile of the role for which they are being considered. An Intellectual and competency score may be generated and used to determine overall success in the position;
3) A candidate's overall personality and personal style fit for the culture of the organization and the other people within the department for which they are being considered. A culture fit score may be generated and used to determine overall success in the position; and
4) How A candidate's will likely progress within the organization and likelihood of future advancement may also be used in the consideration process. A progression score may be generated and used to determine overall success in the position.

Additionally the system and method of the present invention may further include assessment questionnaires and tools that may help to evaluate traits such as leadership, interpersonal, communication, work ethic, goal orientation, capacity to form new directions, stress tolerance, performance, practical judgment, problem solving, goal orientation, strategic judgement, and interdependence skills. An assessment questionnaires and tools score may be generated and used to determine overall success in the position. The score may also be weighted in a manner that provides more or less importance to the aggregated score.

The assessment and questionnaires score may have sub-categories that provide data to predict success in the following categories:
1) Position Fit: Appears to be a fit for and performing well at appropriate levels;
2) Growth: Ready Now for more complex responsibilities;
3) High Potential: for succeeding in more complex positions but needs to remain in position for development; and
4) Development: needed to test and prepare for more complex responsibilities.

The afore-mentioned processes establish a benchmark profile, based on specific work history, skills and experiences with weighting for importance for a specific role. Then, through an automated software process, a potential candidate is then compared to the ideal profile and the resulting match using a unique weighting for the role produces a score that is used in the overall method.

Calculating, for each candidate from a plurality of candidates. A list of attribute values including a value for each attribute from a list of attributes. The method further includes calculating, for each candidate, a first value wherein the first value is calculated based on the list of attribute values. The method further includes reading a list of ideal responses to a set of questions. wherein the set of questions corresponds to the job and reading, for each candidate, a list of responses to the set of questions, wherein the list of responses is provided by the candidate. The method further includes calculating, for each candidate, a list of response values by comparing a list of ideal responses to a list of responses provided by the candidate. Wherein the list of response values includes a value for each response from the list of responses. The method further includes calculating, for each candidate, a second value wherein the second value is calculated based on the list of response values, and calculating, for each candidate, a third value based on the first value and the second value. The method may further include calculating, for each candidate, a third value wherein the third value is calculated based on the list of response values, and calculating, for each candidate, a fourth value based on the first value, the second value, and a third value. The method may be repeated for four or more values and the values may be weighted in any order.

In another embodiment of the present invention, a computer program product including computer instructions for identifying at least one candidate for a job is disclosed. The computer instructions include instructions for calculating, for each candidate from a plurality of candidates, a list of attribute values including a value for each attribute from a list of attributes. The computer instructions further include instructions for calculating, for each candidate, a first value wherein the first value is calculated based on the list of attribute values. The computer instructions further include instructions for reading a list of ideal responses to a set of questions or situations, wherein the set of questions/situations corresponds to the job and reading, for each candidate, a list of responses to the set of questions/situations, wherein the list of responses is provided by the candidate. The computer instructions further include instructions for calculating, for each candidate, a list of response values by comparing the list of ideal responses to the list of responses provided by the candidate, wherein the list of response values includes a value for each response from the list of responses. The computer instructions further include instructions for calculating, for each candidate, a second value wherein the second value is calculated based on the list of response values, and calculating, for each candidate, a third value based on the first value and the second value. The computer instructions further include instructions for calculating, for each candidate, a fourth value wherein the fourth value is calculated based on the list of response values, and calculating, for each candidate, a fourth value based on the first value, the second value, and the third value. Additional values may be generated and calculated depending on the specific role.

In another embodiment of the present invention, a computer system for identifying at least one candidate for a job is disclosed. The computer system includes a processor configured for calculating, for each candidate from a plurality of candidates. A list of attribute values including a value for each attribute from a list of attributes. The processor is further configured for calculating, for each candidate, a first value wherein the first value is calculated based on the list of attribute values. The processor is further configured for reading a list of ideal responses to a set of questions, wherein the set of questions corresponds to the job and reading, for each candidate, a list of responses to the set of questions, wherein the list of responses is provided by the candidate. The processor is further configured for calculating, for each candidate, a list of response values by comparing the list of ideal responses to the list of responses provided by the candidate, wherein the list of response values includes a value for each response from the list of responses. The processor is further configured for calculating, for each candidate, a second value wherein the second value is calculated based on the list of response values, and calculating, for each candidate, a third value based on the first value and the second value. The processor is still further configured for calculating, for each candidate, a fourth value wherein the third value is calculated based on the list of response values, and calculating, for each candidate, a fourth value based on the first value, the second value, and the third value. The processor is yet still further configured for calculating, for each candidate, a separate value wherein the separate value is calculated based on the list of response values, and calculating, for each candidate, a fourth value based on the first value, the second value, and the third value.

Other values may be calculated and incorporated within the selection process such as credit scores, reference ratings, or any other value for selecting an appropriate candidate.

In an another of the present invention, a computer system and method for enabling multi-evaluator/rater feedback for at least one candidate for a job is disclosed. Each evaluator is assigned at least one specific job criteria to score for each candidate via an online computer system. Each evaluator enters scoring information into the computer system via any wired or wireless input device such as an iPhone, laptop computer, tablet and/or desktop computer. The one or more evaluators scores are transformed into data and weighted based on the importance of the data to the evaluators questions. The system takes inputs from one or more evaluators and uses the weighted value to calculate a data point within an algorithm to calculate a final score for each candidate.

The foregoing and other features and advantages of the present invention will be apparent from the following more particular description of the preferred embodiments of the invention, as illustrated in the accompanying drawings.

### BRIEF DESCRIPTION OF THE DRAWINGS

FIG. 1 is a block diagram showing a high level system architecture 100 of a system for executing a candidate selection process, according to one embodiment of the present invention

FIG. 2 is a skills and attribute matrix showing the components and data used during the candidate selection process, according to one embodiment of the present invention.

FIG. 3 is a block diagram showing an embodiment of a computer system useful for implementing an embodiment of the present invention.

FIG. 4 is a flowchart showing the control flow of the candidate selection process, according to one embodiment of the present invention.

FIG. 5 is a flowchart showing the control flow of the candidate selection process, according to one embodiment of the present invention.

The subject matter, which is regarded as the invention, is particularly pointed out and distinctly claimed in the claims at the conclusion of the specification. The foregoing and other features and the advantages of the invention will be apparent from the following detailed description taken in conjunction with the accompanying drawings.

### DETAILED DESCRIPTION

It should be understood that the embodiments below are only examples of the many advantageous uses of the innovative teachings herein. In general statements made in the specification of the present application do not necessarily limit any of the various claimed inventions. Moreover, some statements may apply to some inventive features but not to others.

In general, unless otherwise indicated, singular elements may be in the plural and vice versa with no loss of generality. In the drawing like numerals refer to like parts through several views.

The present invention, according to a preferred embodiment, overcomes problems with the prior art by providing an improved system, method and computer program product for selecting sales candidates and other candidates for a job using statistical processes. The present invention greatly increases the odds of selecting and hiring the best candidates for a job. The present invention further provides a unique assessment process that identifies the best qualities of sales⋅employees and then using these qualities to search for candidates from a pool of candidates. One advantage of the present invention is an increase in the odds of making the best hire for a new position. Another advantage of the present invention is a reduction in hiring costs and reduction in expensive turnover in existing job positions (i.e. higher retention rates). Yet another advantage of the present invention is a reduction in company time spent on the hiring process.

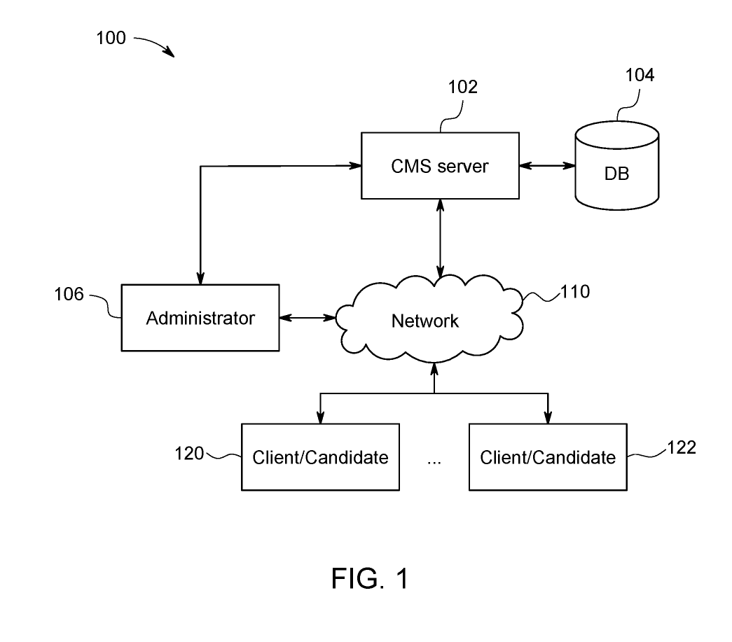

FIG. 1 is a block diagram showing a high level system architecture of system 100 for executing a sales candidate selection process according to one embodiment of the present invention. FIG. 1 illustrates the client-server architecture of one embodiment of the present invention. The exemplary embodiments of the present invention adhere to the system architecture of FIG. 1. FIG. 1 shows a candidate management system (CMS) server 102 connected to the network 110. The CMS server 102 (which is described in more detail below) substantially performs the candidate selection processes of the present invention.

FIG. 1 further shows an embodiment of the present invention wherein clients, or job candidates, interact with the CMS server 102 over a network 110, such as in an enterprise implementation of the management system 100 that services multiple job candidates in more than one geographic location. FIG. 1 shows client computers 120 through 122 connected to a network 110. Client computers 120-122 comprise job candidates running a client application on the client computer so as to participate in the candidate selection process. It should be noted that although FIG. 1 shows only two client computers 120 and 122, the system of the present invention supports any number of client computers.

Administrator 106 is shown to be connected either to the network 110 or directly to CMS server 102. Administrator client 106 is used to administer CMS server 102 and therefore the administrator client can be remotely located via the network 110 or situated within the same intranet as the CMS server 102.

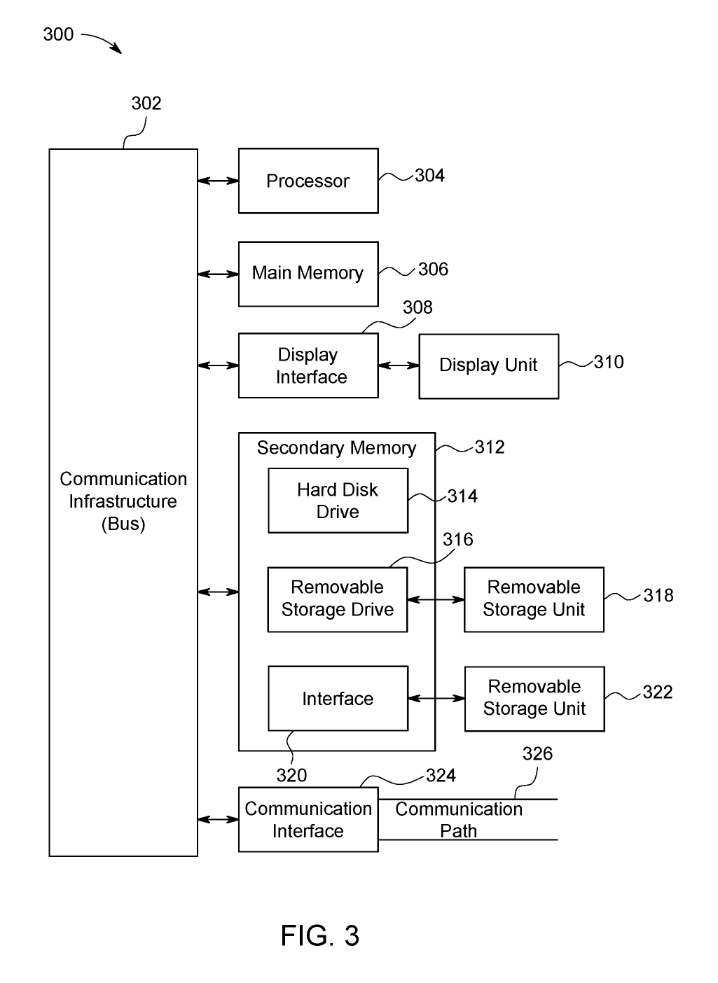

In an embodiment of the present invention, the computer systems of client computers 120 through 122, administrator client 106 and CMS server 102 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system or an equivalent. In another embodiment, the client computers 120 through 122, administrator client 106, and CMS server 102 are a server system, such as SUN Ultra workstations running a Sun OS operating system or IBM RS/6000 workstations and servers running the AIX operating system. The computer systems of client computers 120 through 122, administrator client 106 and CMS server 102 are described in greater detail below with reference to FIG. 3.

In an embodiment of the present invention, the network 110 is a circuit switched network, such as the Public Service Telephone Network (PSTN). In another embodiment, network 110 is a packet switched network. The packet switched network is a wide area network (WAN), such as the global Internet, a private WAN, a local area network (LAN), a telecommunications network or any combination of the above-mentioned networks. In yet another embodiment, the structure of the network 110 is a wired network, a wireless network, a broadcast network or a point-to-point network.

Optionally, the CMS server 102 includes a Web server that connects to the network 110 via a network interface. The CMS server 102 is logically connected to the Web server, which provides a Web interface available to clients (such as clients 120 through 122). This option is advantageous as a Web interface allows any clients having a Web connection to connect to the CMS server 102. A Web interface provides a simple, efficient, highly compatible, economical, and highly available connection to the CMS server 102 to a wide range of clients.

Also shown in FIG. 1 is database 104 coupled to CMS server 102. Database 104 is a repository for data and includes all information necessary for performing the functions of the system 100. Database 104 can be any commercially database, such as an Oracle Database, Enterprise or Personal Edition, available from Oracle Corporation, or a Microsoft SQL Server or Access 2000 database available from Microsoft Corporation. Database 104 may further be managed by a database management system, which is an application that controls the organization, storage and retrieval of data (fields, records, and files) in the databases. A database management system accepts requests for data from an application program and instructs the operating system to transfer the appropriate data. A database management system may also control the security and integrity of a database. Data security prevents unauthorized users from viewing or updating certain portions of the database. A database management system can be any commercially database management system, such as the Oracle E-Business Suite available from Oracle Corporation.

Each client 120-122 runs a client application, such as an application programmed in C++, Visual Basic, a Java applet, a Java scriptlet, Java script, Perl script, an Active X control or any self-sufficient application executing on a client computer. It should also be noted that in the embodiment of the present invention described above, the clients 120-122 and administrator 106 are depicted as separate from CMS server 102. In an alternative embodiment of the present invention, any one or all the clients 120-122 and administrator 106 may be integrated along with CMS server 102. In this alternative embodiment, those entities that are integrated share the same resources.

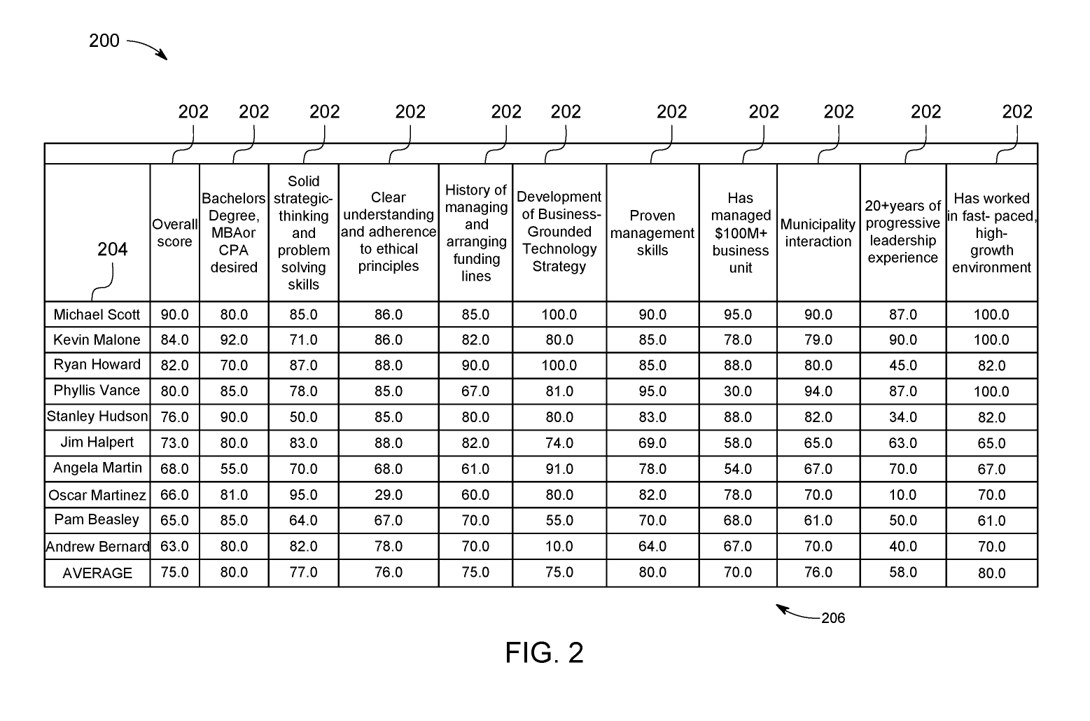

FIG. 2 is an illustration of a skills and attribute matrix 200 used in a candidate selection process, according to one embodiment of the present invention. FIG. 2 shows a matrix 200 containing attribute values for a list of attributes for each of plurality of candidates. Matrix 200 shows a list of attributes and skills located along the top row 202. Although. any number of attributes and skills may be located along the top row 202, the current matrix 200 shows eleven (11) attributes and skills. Matrix 200 further shows a list of job candidate names along the left-most column 204. The body 206 of the matrix 200 includes the attributes values calculated for each candidate. That is, the body 206 of the matrix 200 shows, for each candidate. the value calculated for each attribute and skill located along the top row 202. For example, FIG. 2 shows values general for education, strategic thinking and problem solving, ethical principles, history of managing and arranging funding, development of business technologies, program management, management skills, managing high dollar business units, interaction with local government, years of leadership, and pace of the environment.

In an embodiment of the present invention, the data required to create the attribute values of matrix 200 above are generated through questionnaires, simulations, subjective and objective evaluations, background checks, social media checks, peer feedback, formal and informal tests, etc. for each candidate. The questionnaires, simulations, and tests include questions and information from which the candidates, skills, and attributes can be gleamed from the responses. In an embodiment, the questionnaires, simulations, and tests are provided in Web form to each candidate via a Web page to the client computer 120-122. The candidates proceed to fill out the forms online and answer situational questions and subsequently the relevant data is automatically entered into database 104.

In another embodiment of the present invention, the attribute values calculated for the body 206 of the matrix 200 may be calculated in a variety of ways. In one alternative, at attribute value ranges from 1-100 and the value is calculated based on the data garnered from the candidate. For example, for the attribute “10 years of commercial experience.” the candidate is given an attribute value of 100 if he possesses 10 years or more of commercial experience. If the candidate possesses less than 10 years of commercial experience, he is given an attribute value equal to the number of years of experience he possesses multiplied by a factor of 10. In another example, for the attribute “Stress tolerance” the candidate is given an attribute value of 100 based on his questionnaire responses, he possesses the greatest amount of stress tolerance. For lowers amounts of stress tolerance, the candidate is given a lower attribute value. The candidate is given a zero-attribute value for possessing no stress tolerance qualities. Attribute values may be calculated based on the candidate's responses to questions in the questionnaires, the candidate's reactions to certain test scenarios/situational questions, the candidate's personality test results, third party assessments of the candidate, credit scores, social media posts or any combination of the above scores, tests, situations, and checks.

Matrix 200 shown in FIG. 2 shows attribute values for a list of attributes and skills. In another embodiment of the present invention, matrix 200 may include attribute values for behavioral characteristics, wherein the attribute values may be calculated based on the candidate's responses to questions in the questionnaires, the candidate's reactions to certain test scenarios, the candidate's personality test results, third party assessments of the candidate, credit scores, social media posts or any combination of the above scores, tests, situations, and checks.

FIG. 3 is a block diagram of a computer system useful for implementing an embodiment of the present invention. Computer system 300 of FIG. 3 is a more detailed representation of computers 120 through 122, administrator 106 or server 102. The computer system 300 of FIG. 3 includes one or more processors, such as processor 304. Processor 304 is connected to a communication infrastructure 302 (e.g. a communications bus, cross-over bar or network). Various software embodiments are described in terms of this exemplary computer system. After reading this description, it will become apparent to a person of ordinary skill in the relevant art(s) how to implement the invention using other computer systems and/or computer architectures.

The computer system 300 may include a display interface 308 that forwards graphics, text, and other data from communication infrastructure 302 (or from a frame buffer not shown) for display on the display unit 310. Computer system 300 also includes main memory 306, preferably random access memory (RAM). and may also include a secondary memory 312. Secondary memory 312 may include, for example, a hard disk drive 314 and/or a removable storage drive 316, representing a floppy disk drive, a magnetic tape drive, an optical disk drive, a USB drive, etc. Removable storage drive 316 reads from and/or writes to a removable storage unit 318 in a manner well known to those having ordinary skill in the art. Removable storage unit 318, represents, for example, a floppy disk, magnetic tape, optical disk, USB drive, etc., which is read by and written to by removable storage drive 316. As will be appreciated, removable storage unit 318 includes a computer usable storage medium having stored therein computer software and/or data.

In alternative embodiments, secondary memory 312 may include other similar means for allowing computer programs or other instructions to be loaded into the computer system. Such means may include, for example, a removable storage unit 322 and an interface 320. Examples of such may include a program cartridge and cartridge interface (such as that found in video game devices), a removable memory chip (such as an EPROM. or PROM) and associated socket, and other removable storage units 322 and interfaces 320 which allow software and data to be transferred from the removable storage unit 322 to the computer system.

The computer system may also include a communications interface 324. Communications interface 324 allows software and data to be transferred between the computer system and external devices. Examples of communications interface 324 may include a modem, a network interface (such as an Ethernet card), a communications port, a PCMCIA slot and card, etc. Software and data transferred via communications interface 324 are in the form of signals which may be, for example, electronic, electromagnetic, optical, or other signals capable of being received by communications interface 324. These signals are provided to communications interface 324 via a communications path (i.e., channel) 326. Channel 326 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 306 and secondary memory 312. Removable storage drive 316, a hard disk installed in hard disk drive 314 and signals. These computer program products are means for providing software to the computer system. The computer readable medium allows the computer system to read data, instructions. messages or message packets, and other computer readable information from the computer readable medium. The computer readable medium, for example, may include non-volatile memory, such as Floppy disk, ROM, USB stick, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, which allow a computer to read such computer readable information.

Computer programs (also called computer control logic) are stored in maim memory 306 and/or secondary memory 312. Computer programs may also be received via communications interface 324. Such computer programs, when executed, enable the computer system to perform the features of the present invention as discussed herein. In particular, the computer programs, when executed, enable the processor 304 to perform the features of the computer system. Accordingly, such computer programs represent controllers of the computer system.

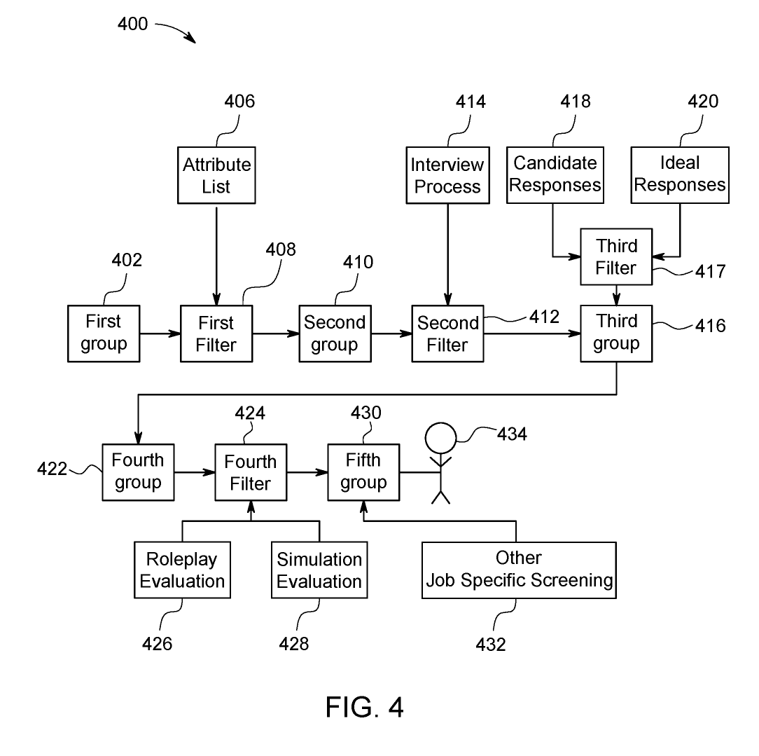

FIG. 4 shows a flow chart where a first group of job candidates 402 selected as the initial pool from which the candidate selection will occur. First filter 408 is executed by reading a list of attribute values 406 for each candidate in the group 402. First group 402 is culled by the first filter 408, thereby generating second group 410 of candidates, which is smaller than first group 402.

Second filter 412 is executed by reading a list of ideal responses to a set of interviews 414 for each candidate in the group 410, results from interview process 414. The second group 410 is culled by second filter 412. Thereby generating third group 416 of candidates, which is smaller than second group 410. The third group 416 is further culled by filter 417. Filter 417 compares candidate responses to questions/scenarios thereby generating a fourth group 422, which is smaller than third group 416. Fourth group 422 is executed by roleplay evaluation 426 and simulation evaluation 428 by placing the candidate in real-world situations and evaluating their responses to the situations presented to the candidate. The fourth group 422 is culled by fourth filter 424, thereby generating a fifth group 430, which is smaller than fourth group 422. Fifth group 430 may be further culled by applying other job specific screening 432 to fifth group 430. Other job specific screening may include but is not limited to credit score, social media interaction, background check, etc., thereby coming out with one or more potential candidate matches 434.

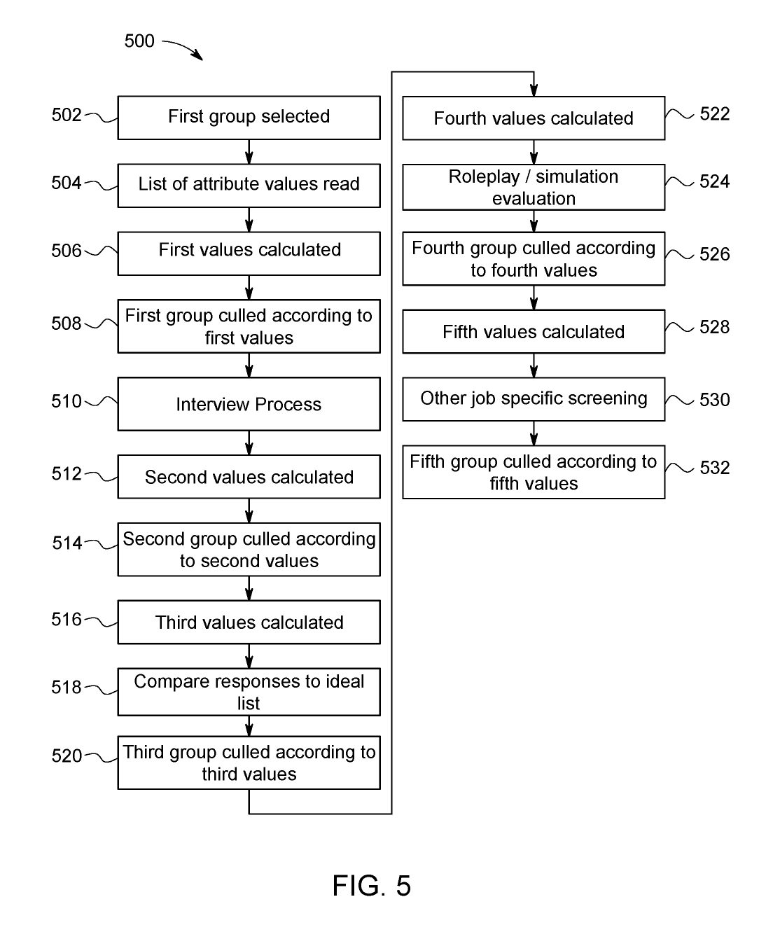

FIG. 5 is a flowchart showing the control flow of the candidate selection process, according to one embodiment of the present invention. FIG. 5 begins with step 502, wherein a first group of job candidates 402 are selected as the initial pool from which the candidate selection will occur. In step 504, first filter 408 of FIG. 4 is executed by reading a list of attribute values 504 for each candidate in group 502. That is, for each candidate in group 502, CMS server 102 reads an attribute value list 406 similar or identical to matrix 200. In step 506, CMS server 102 calculates a first value for each candidate in group 402. wherein the first value for each candidate is based on the attribute values corresponding to that candidate.

In an embodiment of the present invention, the first value calculated for each candidate is a simple sum or average multiplied by a factor of 10. For example, referring to the attribute values corresponding to candidate Michael Scott in matrix 200, the first value may be a sum of the attribute values for Michael Scott or the first value may be an average of the attribute values. In another embodiment of the present invention, a first value can be calculated for a candidate by taking a weighted average of the attribute values for that candidate multiplied by a factor of 10, wherein weights are associated with certain attribute values. For example, it may be the case that of all the attributes in matrix 200, the attributes “Ethical Principles” and “Proven Management Skills” are more important than the other attributes. In this case, a first value for candidate Michael Scott can be calculated by taking an average of the attribute values for Michael Scott, with extra weight being given to attribute values for attributes “Ethical Principles” and “Proven Management Skills”

In step 508, the first group 402 is culled by eliminating those candidates with a first value below a predetermined threshold value, thereby generating second group 410 of candidates, which is smaller than first group 402.

In step 510, the second filter 412 is executed by initiating interview process 414, those candidates that are offered interviews as calculated in step 512 and those who accept the interview as calculated in step 514 thereby generating third group 416 values in step 516. In step 518, third group 416 is further limited by applying third filter 417. In step 520, candidate responses 418 to interview questions are compared to ideal responses 420 for each candidate in group 416. For each candidate in the group 416, CMS server 102 reads a list of questions and responses and compares the responses for each candidate in third group 416. In step 522, values for fourth group 422 are calculated. In step 524, roleplay/simulation evaluations are read by CMS server 102 are applied in step 526 by fourth filter 424 to provide fifth group 430 as calculated in step 528. In step 530, CMS server 102 applies other job specific screening 432 and calculates a fifth value leading to the selection of one or more candidates 434.

In another embodiment of the present invention, a first, second, third, fourth, and fifth values may be calculated for a candidate by taking a weighted average of the percentage of the candidate's responses.

In steps 508, 514, 520, 526 and 532 the groups 410, 422, and 430 are culled by eliminating those candidates with a value below a predetermined threshold value, thereby generating a pool of candidates, which is smaller than the previous group of candidates.

In steps 506, 512, 516, 522, and 528 values are calculated for each candidate, wherein the values for each candidate in steps 512, 616, 522, and 528 are based on a combination of the previous values. In one embodiment of the present invention, the second, third, fourth and fifth values may be calculated by simply summing or averaging the first and second values. In another alternative, the second, third, fourth and fifth values may be calculated by using a formula involving the previous values, such as: two thirds of the first value plus one third of the second value. In another alternative, a weighted average may be taken of second, third, fourth and fifth values, wherein the first value is given a weight of two thirds and the second value is given a weight of one third, etc.

What has been shown and discussed is a highly-simplified depiction of a programmable computer apparatus. Those skilled in the art will appreciate that other low-level components and connections are required in any practical application of a computer apparatus.

Although specific embodiments of the invention have been disclosed. Those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover all such applications, modifications, and embodiments within the scope of the present invention.

We claim the following:

1. A method for identifying at least one candidate for a job, comprising:
calculating, for each candidate from a plurality of candidates, a list of attribute values including a value for each attribute from a list of attributes;
calculating, for each candidate, a first value wherein the first value is calculated based on the list of attribute values;
reading a list of ideal responses to a set of questions, wherein the set of questions corresponds to the job;
reading, for each candidate, a list of responses to the set of questions, wherein the list of responses was provided by the candidate;
calculating, for each candidate, a list of response values by comparing the list of ideal responses to the list of responses provided by the candidate, wherein the list of response values includes a value for each response from the list of responses;
calculating, for each candidate, a second of value wherein the second of values is calculated based on the list of response values; and
calculating, for each candidate, a third, a fourth, and fifth values based on the previous value.

2. The method of claim 1, wherein the first step of calculating further comprises: calculating, for each candidate from a plurality of candidates, a list of attribute values including a value for each attribute from a list of attributes, wherein each attribute is pertinent to a sales job.

3. The method of claim 2, wherein the second step of calculating further comprises: calculating, for each candidate, a first value wherein the first value is calculated based on the list of attribute values and weights associated with each attribute value.

4. The method of claim 1, wherein the first step of reading further comprises: reading a list of ideal responses to a set of questions, wherein the set of questions corresponds to the job and wherein the ideal responses were provided by an ideal employee holding the job.

5. The method of claim 4, wherein the second step of reading further comprises: reading, for each candidate, a list of responses to the set of questions, wherein the list of responses was provided by the candidate over the Internet.

6. The method of claim 5, wherein the fourth step of calculating further comprises: calculating, for each candidate, a second value wherein the second value is calculated based on the list of response values and weights associated with each response value.

7. The method of claim 6, wherein the step of calculating further comprises: calculating, for each candidate, a third, a fourth and a fifth value comprising two-thirds of the previous value and one-third of the second value.

8. A computer program product including computer instructions for identifying at least one candidate for a job, the computer instructions including instructions for:
calculating, for each candidate from a plurality of candidates, a list of attribute values including a value for each attribute from a list of attributes;
calculating, for each candidate, a first value wherein the first value is calculated based on the list of attribute values;
reading a list of ideal responses to a set of questions, wherein the set of questions corresponds to the job;
reading, for each candidate, a list of responses to the set of questions, wherein the list of responses was provided by the candidate;
calculating, for each candidate, a list of response values by comparing the list of ideal responses to the list of responses provided by the candidate, wherein the list of response values includes a value for each response from the list of responses;
calculating, for each candidate, a second value wherein the second value is calculated based on the list of response values; and
calculating, for each candidate, a third, a fourth, and fifth values based on the previous value.

9. The computer program product of claim 8, wherein the first instructions for calculating further comprise instructions for calculating, for each candidate from a plurality of candidates, a list of attribute values including a value for each attribute from a list of attributes, wherein each attribute is pertinent to the job.

10. The computer program product of claim 9, wherein the second instructions for calculating further comprise instructions for: calculating, for each candidate, a first value wherein the first value is calculated based on the list of attribute values and weights associated with each attribute value.

11. The computer program product of claim 9, further comprising instructions for: setting an interview with any candidate from the plurality of candidates with a third value that exceeds a threshold value.

12. A computer system for identifying at least one candidate for a job, comprising a processor configured for:
calculating, for each candidate from a plurality of candidates, a list of attribute values including a value for each attribute from a list of attributes;
calculating, for each candidate, a first value wherein the first value is calculated based on the list of attribute values;
reading a list of ideal responses to a set of questions, wherein the set of questions corresponds to the job;
reading, for each candidate, a list of responses to the set of questions, wherein the list of responses was provided by the candidate;
calculating, for each candidate, a list of response values by comparing the list of ideal responses to the list of responses provided by the candidate, wherein the list of response values includes a value for each response from the list of responses;
calculating, for each candidate, a second value wherein the second value is calculated based on the list of response values; and
calculating, for each candidate, a third, a fourth, and fifth values based on the previous value.
